(19) United States
(12) Patent Application Publication
(10) Pub. No.: US 2016/0065302 A1
(43) Pub. Date: Mar. 3, 2016

(54) Method and Apparatus for Communication

(71) Applicant: NOKIA SOLUTIONS AND NETWORKS OY, Espoo (FI)

(72) Inventors: Claudio ROSA, Randers (DK); Frank FREDERIKSEN, Klarup (DK)

(21) Appl. No.: 14/781,983

(22) PCT Filed: Apr. 5, 2013
(86) PCT No.: PCT/EP2013/057154

§ 371 Date: Oct. 2, 2015

(51) Int. Cl. H04B 7/26; H04W 56/00; H04W 72/04

(52) U.S. Cl. CPC H04B 7/2615; H04W 72/044; H04W 56/004

(57) ABSTRACT

A method including receiving signals at a first frequency and at a second frequency; and switching between the first frequency and the second frequency during one of a plurality of subframes within a radio frame for transmission subsequent to said receiving.

Some embodiments relates to a method and apparatus and in particular but not exclusively to a method and apparatus for use in a system with carrier aggregation.

A communication system can be seen as a facility that enables communications between two or more entities such as a communication device, e.g. mobile stations (MS) or user equipment (UE), and/or other network elements or nodes, e.g. Node B or base transceiver station (BTS), associated with the communication system. A communication system typically operates in accordance with a given standard or specification which sets out what the various entities associated with the communication system are permitted to do and how that should be achieved.

Wireless communication systems include various cellular or other mobile communication systems using radio frequencies for sending voice or data between stations, for example between a communication device and a transceiver network element. Examples of wireless communication systems may comprise public land mobile network (PLMN), such as global system for mobile communication (GSM), the general packet radio service (GPRS) and the universal mobile telecommunications system (UMTS).

A mobile communication network may logically be divided into a radio access network (RAN) and a core network (CN). The core network entities typically include various control entities and gateways for enabling communication via a number of radio access networks and also for interfacing a single communication system with one or more communication systems, such as with other wireless systems, such as a wireless Internet Protocol (IP) network, and/or fixed line communication systems, such as a public switched telephone network (PSTN). Examples of radio access networks may comprise the UMTS terrestrial radio access network (UTRAN) and the GSM/EDGE radio access network (GERAN).

A geographical area covered by a radio access network is divided into cells defining a radio coverage area provided by a transceiver network element, such as a base station or Node B. A single transceiver network element may serve a number of cells. A plurality of transceiver network elements is typically connected to a controller network element, such as a radio network controller (RNC).

Carrier aggregation can be used to increase performance. In carrier aggregation a plurality of carriers are aggregated to increase bandwidth. Carrier aggregation comprises aggregating a plurality of component carriers into a carrier that is referred to in this specification as an aggregated carrier.

There is provided according to a first aspect a method comprising: receiving signals at a first frequency and at a second frequency; and switching between the first frequency and the second frequency during one of a plurality of subframes within a radio frame for transmission subsequent to said receiving.

The first frequency signal and said second frequency signal may be offset by a timing offset.

The timing offset may be determined to be at least as long as a time required for said switching between said first frequency and said second frequency.

The timing offset may be determined to be shorter than half the time required for one of said subframes.

The timing offset may be determined using: TSWITCH−ΔTP≦timing offset; (TSubframe−TSWITCH)−ΔTP≧timing offset; wherein: ΔTP=2*TPPCell−TPSCell TSWITCH is a time required for said switching between said first frequency and said second frequency; Tsubframe is the length of said subframe; TPPCell is a propagation delay associated with said signal transmitted at said first frequency; and TPSCell is a propagation delay associated with said signal transmitted at said second frequency.

The method may comprise transmitting signals on said first frequency at least one of said plurality of subframes, prior to said switching. The at least one subframe used to transmit signals on said first frequency may be a further or different subframe.

The method may comprise: transmitting signals on said second frequency using a further at least one of said plurality of subframes, after said switching. The at least one subframe used to transmit signals on said second frequency may be a further or different subframe.

At least one of said first and second frequency may be associated with at least one primary cell.

At least one of said first and second frequency may be associated with at least one secondary cell.

A computer program product may be configured to perform a method according to the first aspect.

There is provided according to a second aspect a method comprising: determining a timing offset between first transmissions in a first frequency and second transmissions in a second frequency to a communication device; and offsetting subsequent transmissions in the first frequency and in the second frequency to the communication device using the timing offset.

The timing offset may be at least as long as a time required by a user equipment to switch between said first frequency and said second frequency.

The timing offset may be shorter than half the length of a subframe within a radio frame for transmission.

The timing offset may further allow for at least one of a first propagation delay associated with said first transmission and a second propagation delay associated with said second transmissions.

The timing offset is determined using: TSWITCH−ΔTP≦timing offset; (TSubframe−TSWITCH)−ΔTP≧timing offset; wherein: ΔTP=2*TPPCell−TPSCell; TSWITCH a time required by a user equipment to switch between said first frequency and aid second frequency; Tsubframe is a length of a subframe within a radio frame for transmission; TPPCell is a propagation delay associated with said first transmissions; and TPSCell is a propagation delay associated with said second transmissions.

At least one of said first and second frequency may be associated with at least one primary cell.

At least one of said first and second frequency may be associated with at least one secondary cell.

A computer program product may be configured to perform a method according to the second aspect.

There is provided according to a third aspect an apparatus comprising: at least one processor; and at least one memory including program code; the at least one memory and the computer program configured to, with the at least one processor cause the apparatus to perform: receiving signals at a first frequency and at a second frequency; and switching between the first frequency and the second frequency during one of a plurality of subframes within a radio frame for transmission subsequent to said receiving.

The first frequency signal and said second frequency signal may be offset by a timing offset.

The timing offset may be determined to be at least as long as a time required for said switching between said first frequency and said second frequency.

The timing offset may be determined to be shorter than half the time required for one of said subframes.

The timing offset may be determined using: TSWITCH−ΔTP≦timing offset; (TSubframe−TSWITCH)−ΔTP≧timing offset; wherein: ΔTP=2*TPPCell−TPSCell; TSWITCH is a time required for said switching between said first frequency and said second frequency; Tsubframe is the length of said subframe; TPPCell is a propagation delay associated with said signal transmitted at said first frequency; and TPSCell is a propagation delay associated with said signal transmitted at said second frequency.

The apparatus may be configured to perform: transmitting signals on said first frequency at least one of said plurality of subframes, prior to said switching. The at least one subframe used to transmit signals on said first frequency may be a further or different subframe.

The apparatus may be configured to perform: transmitting signals on said second frequency using a further at least one of said plurality of subframes, after said switching. The at least one subframe used to transmit signals on said second frequency may be a further or different subframe.

At least one of said first and second frequency may be associated with at least one primary cell.

At least one of said first and second frequency may be associated with at least one secondary cell.

A user equipment may an apparatus according to the third aspect.

There is provided according to a fourth aspect an apparatus comprising: at least one processor; and at least one memory including program code; the at least one memory and the computer program configured to, with the at least one processor cause the apparatus to perform: determining a timing offset between first transmissions in a first frequency and second transmissions in a second frequency to a communication device; and offsetting subsequent transmissions in the first frequency and in the second frequency to the communication device using the timing offset.

The timing offset may be at least as long as a time required by a user equipment to switch between said first frequency and said second frequency.

The timing offset may be shorter than half the length of a subframe within a radio frame for transmission.

The timing offset may further allow for at least one of a first propagation delay associated with said first transmission and a second propagation delay associated with said second transmissions.

The timing offset may be determined using: TSWITCH−ΔTP≦timing offset; (TSubframe−TSWITCH)−ΔTP≧timing offset wherein: ΔTP=2*TPPCell−TPSCell; TSWITCH a time required by a user equipment to switch between said first frequency and aid second frequency; Tsubframe is a length of a subframe within a radio frame for transmission; TPPCell is a propagation delay associated with said first transmissions; and TPSCell is a propagation delay associated with said second transmissions.

At least one of said first and second frequency may be associated with at least one primary cell.

At least one of said first and second frequency may be associated with at least one secondary cell.

A base station may comprising an apparatus according to the fourth aspect.

There is provided according to a fifth aspect an apparatus comprising: means for receiving signals at a first frequency and at a second frequency; and means for switching between the first frequency and the second frequency during one of a plurality of subframes within a radio frame for transmission subsequent to said receiving.

The first frequency signal and said second frequency signal may be offset by a timing offset.

The timing offset may be determined to be at least as long as a time required for said switching between said first frequency and said second frequency.

The timing offset may be determined to be shorter than half the time required for one of said subframes.

The timing offset may be determined using: TSWITCH−ΔTP≦timing offset; (TSubframe−TSWITCH)−ΔTP≧timing offset; wherein: ΔTP=2*TPPCell−TPSCell; TSWITCH is a time required for said switching between said first frequency and said second frequency; Tsubframe is the length of said subframe; TPPCell is a propagation delay associated with said signal transmitted at said first frequency; and TPSCell is a propagation delay associated with said signal transmitted at said second frequency.

The apparatus may comprise means for transmitting signals on said first frequency at least one of said plurality of subframes, prior to said switching. The at least one subframe used to transmit signals on said first frequency may be a further or different subframe.

The apparatus may comprise means for transmitting signals on said second frequency using a further at least one of said plurality of subframes, after said switching. The at least one subframe used to transmit signals on said second frequency may be a further or different subframe.

At least one of said first and second frequency may be associated with at least one primary cell.

At least one of said first and second frequency may be associated with at least one secondary cell.

A user equipment may an apparatus according to the fifth aspect.

There is provided according to a sixth aspect an apparatus comprising: means for determining a timing offset between first transmissions in a first frequency and second transmissions in a second frequency to a communication device; and means for offsetting subsequent transmissions in the first frequency and in the second frequency to the communication device using the timing offset.

The timing offset may be at least as long as a time required by a user equipment to switch between said first frequency and said second frequency.

The timing offset may be shorter than half the length of a subframe within a radio frame for transmission.

The timing offset may further allow for at least one of a first propagation delay associated with said first transmission and a second propagation delay associated with said second transmissions.

The timing offset may be determined using: TSWITCH−ΔTP≦timing offset; (TSubframe−TSWITCH)−ΔTP≧timing offset wherein: ΔTP=2*TPPCell−TPSCell; TSWITCH a time required by a user equipment to switch between said first frequency and aid second frequency; Tsubframe is a length of a subframe within a radio frame for transmission; TPPCell is a propagation delay associated with said first transmissions; and TPSCell is a propagation delay associated with said second transmissions.

At least one of said first and second frequency may be associated with at least one primary cell.

At least one of said first and second frequency may be associated with at least one secondary cell.

A base station may comprising an apparatus according to the sixth aspect.

There is provided according to a seventh aspect an apparatus comprising: a receiver configured to receive signals at a first frequency and at a second frequency; and a controller configured to switch between the first frequency and the second frequency during one of a plurality of subframes within a radio frame for transmission subsequent to said receiving.

The first frequency signal and said second frequency signal may be offset by a timing offset.

The timing offset may be determined to be at least as long as a time required for said switching between said first frequency and said second frequency.

The timing offset may be determined to be shorter than half the time required for one of said subframes.

The timing offset may be determined using: TSWITCH−ΔTP≦timing offset; (TSubframe−TSWITCH)−ΔTP≧timing offset; wherein: ΔTP=2*TPPCell−TPSCell; TSWITCH is a time required for said switching between said first frequency and said second frequency; Tsubframe is the length of said subframe; TPPCell is a propagation delay associated with said signal transmitted at said first frequency; and TPSCell is a propagation delay associated with said signal transmitted at said second frequency.

The apparatus may further comprise a transmitter configured to transmit signals on said first frequency at least one of said plurality of subframes, prior to said switching. The at least one subframe used to transmit signals on said first frequency may be a further or different subframe.

The apparatus may further comprise a transmitter configured to transmit signals on said second frequency using a further at least one of said plurality of subframes, after said switching. The at least one subframe used to transmit signals on said second frequency may be a further or different subframe.

At least one of said first and second frequency may be associated with at least one primary cell.

At least one of said first and second frequency may be associated with at least one secondary cell.

A user equipment may an apparatus according to the seventh aspect.

There is provided according to a eight aspect an apparatus comprising: a controller configured to determine a timing offset between first transmissions in a first frequency and second transmissions in a second frequency to a communication device; and offset subsequent transmissions in the first frequency and in the second frequency to the communication device using the timing offset.

The timing offset may be at least as long as a time required by a user equipment to switch between said first frequency and said second frequency.

The timing offset may be shorter than half the length of a subframe within a radio frame for transmission.

The timing offset may further allow for at least one of a first propagation delay associated with said first transmission and a second propagation delay associated with said second transmissions.

The timing offset may be determined using: TSWITCH−ΔTP≦timing offset; (TSubframe−TSWITCH)−ΔTP≧timing offset wherein: ΔTP=2*TPPCell−TPSCell; TSWITCH a time required by a user equipment to switch between said first frequency and aid second frequency; Tsubframe is a length of a subframe within a radio frame for transmission; TPPCell is a propagation delay associated with said first transmissions; and TPSCell is a propagation delay associated with said second transmissions.

At least one of said first and second frequency may be associated with at least one primary cell.

At least one of said first and second frequency may be associated with at least one secondary cell.

A base station may comprising an apparatus according to the eighth aspect.

Embodiments may combine one or more features from one or more aspects.

Embodiments will now be described in further detail, by way of example only, with reference to the following examples and accompanying drawings, in which:

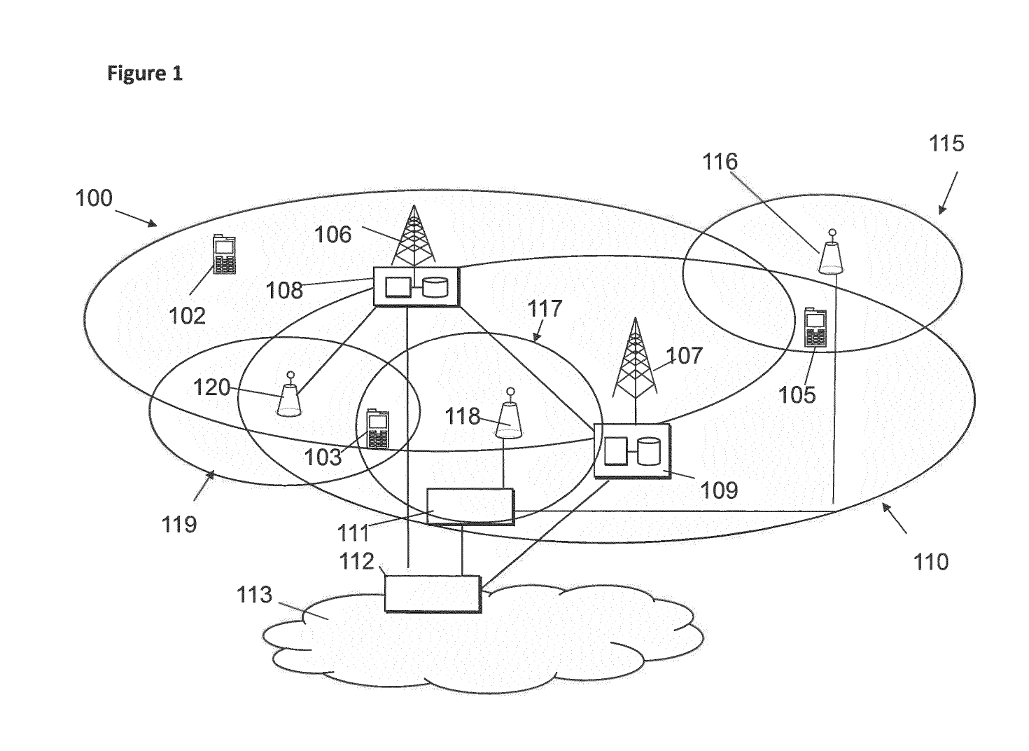

FIG. 1 shows a schematic diagram of a communication system comprising a base station and a plurality of communication devices;

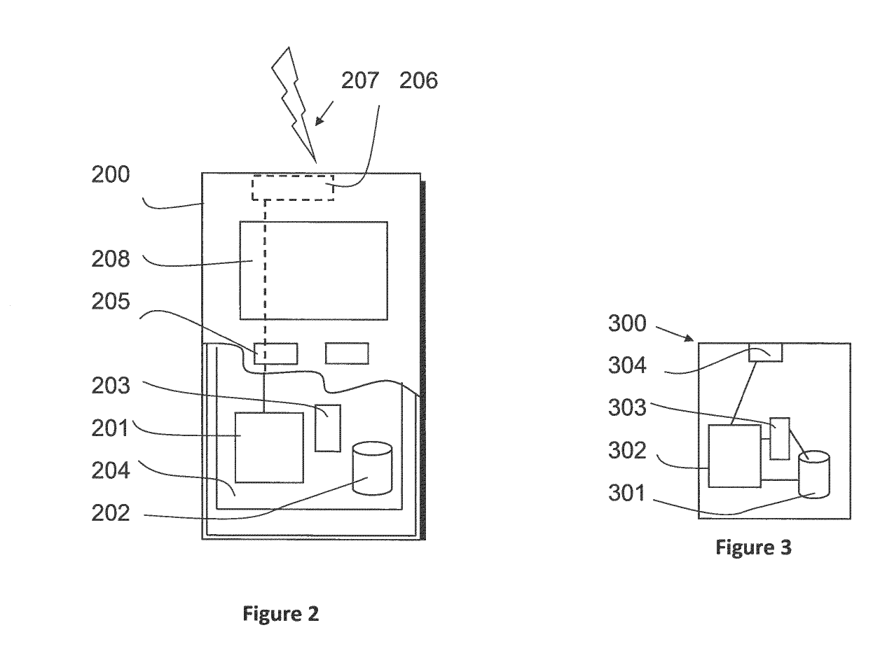

FIG. 2 shows a schematic diagram of a mobile communication device according to some embodiments;

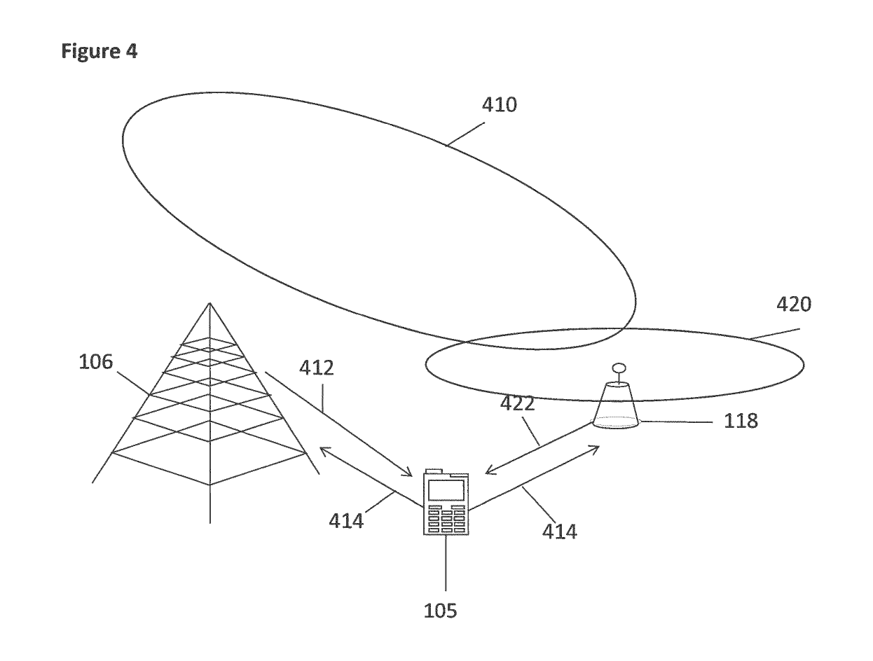

FIG. 3 shows a schematic diagram of a control apparatus according to some embodiments;

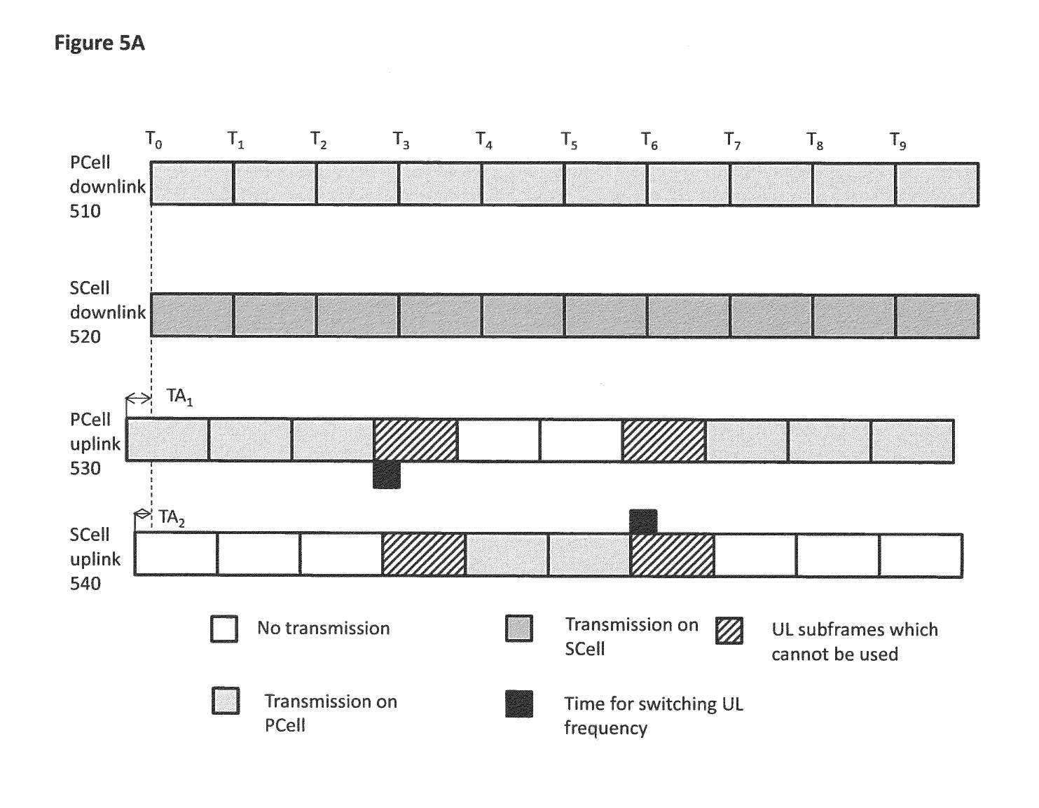

FIG. 4 shows a schematic diagram of part of a communication system according to some embodiments;

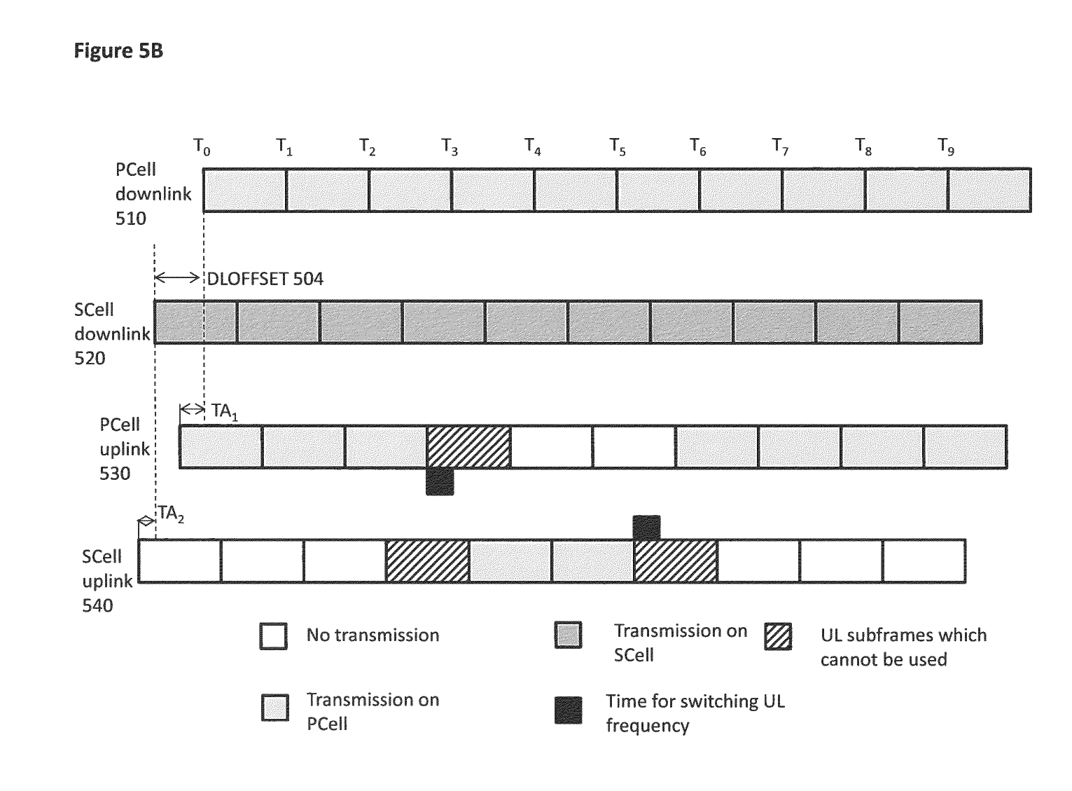

FIGS. 5A and B show transmission timing diagrams according to some embodiments;

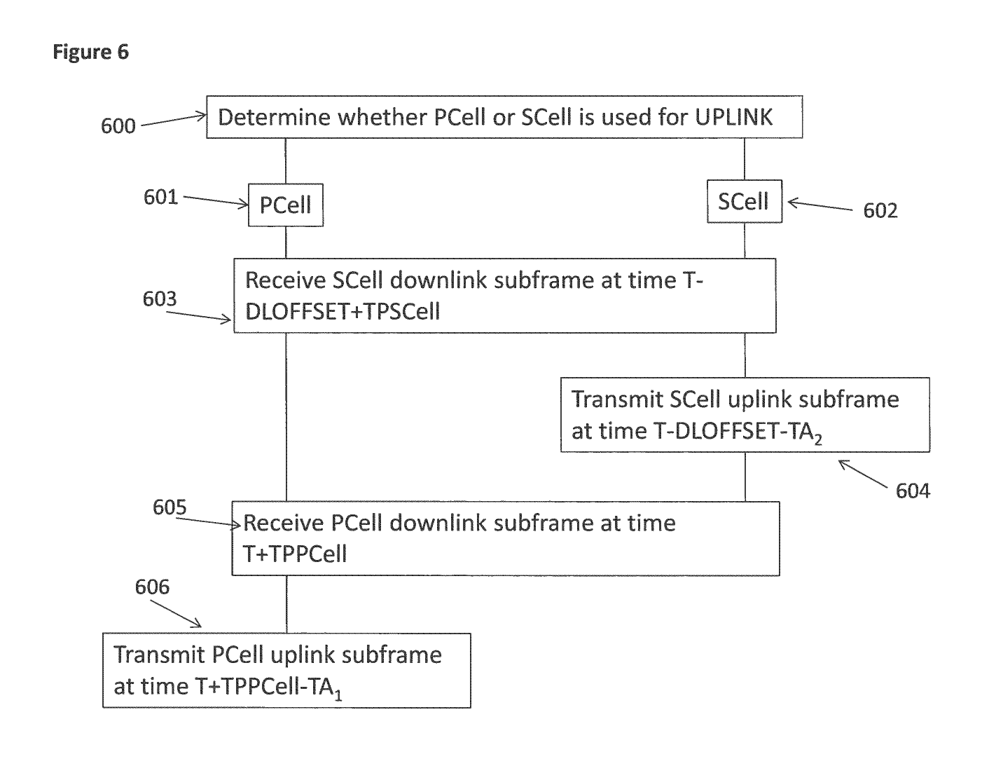

FIG. 6 shows a flow diagram of a method of an embodiment

In the following certain exemplifying embodiments are explained with reference to a wireless or mobile communication system serving mobile communication devices. Before explaining in detail the exemplifying embodiments, certain general principles of a wireless communication system and mobile communication devices are briefly explained with reference to FIGS. 1 to 3 to assist in understanding the technology underlying the described examples.

In a wireless communication system mobile communication devices or user equipment (UE) 102, 103, 105 are provided wireless access via at least one base station or similar wireless transmitting and/or receiving node or point. In the FIG. 1 an example of two overlapping access systems or radio service areas of a cellular system 100 and 110 and three smaller radio service areas 115, 117 and 119 provided by base stations 106, 107, 116, 118 and 120 are shown. Each mobile communication device and base station may have one or more radio channels open at the same time and may send signals to and/or receive signals from more than one source. It is noted that the radio service area borders or edges are schematically shown for illustration purposes only in FIG. 1. It shall also be understood that the sizes and shapes of radio service areas may vary considerably from the shapes of FIG. 1. A base station site can provide one or more cells. A base station can also provide a plurality of sectors, for example three radio sectors, each sector providing a cell or a subarea of a cell. All sectors within a cell may be served by the same base station.

Base stations are typically controlled by at least one appropriate controller apparatus so as to enable operation thereof and management of mobile communication devices in communication with the base stations. In FIG. 1 control apparatus 108 and 109 is shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. In the example, stations 116 and 118 are connected via a gateway 111 whilst station 120 connects via the controller apparatus 108. In some embodiments, the smaller stations may not be provided.

The small cells provided by the smaller base stations may be femto cells, pico cells, relays, remote radio heads or any other small cell.

A possible mobile communication device will now be described in more detail with reference to FIG. 2 showing a schematic, partially sectioned view of a communication device 102. Such a communication device is often referred to as user equipment (UE) or terminal. An appropriate mobile communication device may be provided by any device capable of sending and receiving radio signals. Non-limiting examples include a mobile station (MS) or mobile device such as a mobile phone or what is known as a ‘smart phone’, a computer provided with a wireless interface card or other wireless interface facility, personal data assistant (PDA) provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. Users may also be provided broadcast or multicast data. Non-limiting examples of the content include downloads, television and radio programs, videos, advertisements, various alerts and other information.

The mobile device 102 may receive signals over an air interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A wireless communication device can be provided with a Multiple Input/Multiple Output (MIMO) antenna system. MIMO arrangements as such are known. MIMO systems use multiple antennas at the transmitter and receiver along with advanced digital signal processing to improve link quality and capacity. Although not shown in FIGS. 1 and 2, multiple antennas can be provided, for example at base stations and mobile stations, and the transceiver apparatus 206 of FIG. 2 can provide a plurality of antenna ports. More data can be received and/or sent where there are more antenna elements. A station may comprise an array of multiple antennas. Signalling and muting patterns can be associated with TX antenna numbers or port numbers of MIMO arrangements.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

FIG. 3 shows an example of a control apparatus for a communication system, for example to be coupled to and/or for controlling a station of an access system, such as a base station. In some embodiments, base stations comprise a separate control apparatus. In other embodiments, the control apparatus can be another network element such as a radio network controller. In some embodiments, each base station may have such a control apparatus as well as a control apparatus being provided in a radio network controller. The control apparatus 109 can be arranged to provide control on communications in the service area of the system. The control apparatus 109 comprises at least one memory 301, at least one data processing unit 302, 303 and an input/output interface 304. Via the interface the control apparatus can be coupled to a receiver and a transmitter of the base station. For example the control apparatus 109 can be configured to execute an appropriate software code to provide the control functions.

The communication devices 102, 103, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

An example of wireless communication systems are architectures standardized by the 3rd Generation Partnership Project (3GPP). A latest 3GPP based development is often referred to as the long-term evolution (LTE) of the Universal Mobile Telecommunications System (UMTS) radio-access technology. The various development stages of the 3GPP LTE specifications are referred to as releases. More recent developments of the LTE are often referred to as LTE Advanced (LTE-A). The LTE employs a mobile architecture known as the Evolved Universal Terrestrial Radio Access Network (E-UTRAN). Base stations of such systems are known as evolved or enhanced Node Bs (eNBs) and may provide E-UTRAN features such as user plane Radio Link Control/Medium Access Control/Physical layer protocol (RLC/MAC/PHY) and control plane Radio Resource Control (RRC) protocol terminations towards the communication devices. Other examples of radio access system include those provided by base stations of systems that are based on technologies such as wireless local area network (WLAN) and/or WiMax (Worldwide Interoperability for Microwave Access).

A feature of LTE-Advanced is that it is capable of providing carrier aggregation. For example, Release 10 (Rel-10) of the E-UTRA specifications introduces Carrier Aggregation (CA), where two or more component carriers (CCs) are aggregated in order to support wider transmission bandwidths up to 100 MHz. In CA it is possible to configure a UE to aggregate a different number of CCs originating from the same eNodeB (eNB) and of possibly different bandwidths in the uplink (UL) and/or downlink (DL).

When CA is configured, the UE only has one RRC connection with the network. At RRC connection establishment/re-establishment/handover, one serving cell provides the NAS (Network access stratum) mobility information (e.g. Tracking Area Identity), and at RRC connection re-establishment/handover, one serving cell provides the security input. This cell is referred to as the Primary Cell (PCell). In the downlink, the carrier corresponding to the PCell is the Downlink Primary Component Carrier (DL PCC) while in the uplink it is the Uplink Primary Component Carrier (UL PCC).

Depending on UE capabilities, Secondary Cells (SCells) can be configured to form together with the PCell a set of serving cells. In the downlink, the carrier corresponding to an SCell is a Downlink Secondary Component Carrier (DL SCC) while in the uplink it is an Uplink Secondary Component Carrier (UL SCC).

The configured set of serving cells for a UE therefore always consists of one PCell and one or more SCells:
For each SCell the usage of uplink resources by the UE in addition to the downlink ones is configurable (the number of DL SCCs configured is therefore always larger than or equal to the number of UL SCCs and no SCell can be configured for usage of uplink resources only);
From a UE viewpoint, each uplink resource only belongs to one serving cell;
The number of serving cells that can be configured depends on the aggregation capability of the UE;
PCell can only be changed with handover procedure (i.e. with security key change and RACH procedure);
PCell is used for transmission of PUCCH;
Re-establishment is triggered when the PCell experiences radio link failure (RLF), not when SCells experience RLF;
NAS information is taken from the PCell.

The reconfiguration, addition and removal of the SCells can be performed by RRC.

In addition to carrier aggregation, Rel-10 introduces the possibility to de-activate the SCells in order to reduce the UE power consumption. RF circuitry and potential higher sampling rates for higher bandwidths will increase power consumption.

The UE monitoring activity of a de-activated SCell is reduced as no PDCCH (physical downlink control channel) monitoring nor CQI (channel quality indicator) measurements are required. The UL activity in a de-activated SCell is also stopped (no SRS sounding reference signal is required). However, Rel-10 only supports deactivation of SCells and the UE-specific PCell is always assumed to be activated.

PCell and SCells may also be used in inter-(e)NB carrier aggregation where the PCell is provided by a first base station and the SCell is provided by a second base station such as shown in FIG. 4.

In some embodiments, the first base station may be one of a macro cell or a small cell. In some embodiments, the second base station may be one of a macro cell or a small cell.

FIG. 4 shows a base station 106 configured to provide a PCell 410 at a first carrier frequency (F1). The base station 106 is configured to communicate with a user equipment 104 using a downlink 412 and an uplink 414. A smaller base station 118 is configured to provide an SCell 420 at a second carrier frequency (F2). The smaller base station 118 is configured to communicate with the UE 104 using a downlink 422 and the uplink 414. The UE 105 is configured to receive data from both the base station 106 and the base station 420 at the same time. The uplink 414 of the UE is configured to switch between transmitting data to the base station 106 using the PCell 410 and transmitting data to the base station 118 using the SCell 420.

In some embodiments the base station may provide a PCell and at least one SCell. In some embodiments the smaller base station may provide at least one SCell. Some embodiments may comprise the UE using the method detailed below to switch between PCells and one or more SCells provided by one or more large and/or small cells.

In network deployments with dedicated carriers for small cell layers inter-site CA may provide low cost transport for small cells and enable macro cells to offload UEs to small cells with minimal service degradation to the UEs. In some embodiments, the performance provided to the UE in terms of downlink throughput and mobility robustness with rapidly varying radio conditions may improve.

Some embodiments may enable inter-(e)NB CA with non-ideal backhaul to be provided with individual uplink control information (UCI) to the different transmission nodes/eNBs. When UCI is only delivered via the PCell, information on Hybrid automatic repeat request acknowledgement/not-acknowledgement (HARQ ACK/NACK) and channel quality indicators (CQI) may not be available at the transmission node hosting the SCell when required. This may result in a delay which may limit the achievable gains with inter-site CA gains.

UCI may be provided separately by configuring independent uplink control channel resources for the PCell and the SCell such that the uplink control channel transmission on the PCell and the SCell are completely independent. However, this may require the UE to support simultaneous transmission on multiple carriers in the UL. Simultaneous uplink transmission may increase the requirements for the UE in terms of added hardware and may reduce the transmission efficiency due to increased power consumption requirements.

Some embodiments may enable the UE to switch in time between uplink PCell transmission and uplink SCell transmission.

FIG. 5A shows a timing diagram for downlink transmissions from the PCell, downlink transmission from the SCell, uplink transmissions to the PCell and uplink transmission to the SCell.

The PCell downlink transmissions 510 occur in sub frames which are transmitted at times T₀ to T₉ respectively.

The SCell uplink transmissions 520 occur in subframes which are transmitted at times T₀ to T₉ respectively.

The transmission time of each of the respective PCell uplink subframes 530 precedes the transmission time of the respective PCell downlink subframes 510 by a timing advance time interval TA₁.

The transmission time of each of the respective SCell uplink subframes 540 precedes the respective transmission time of the SCell downlink subframes by a timing advance time interval TA₂.

The time interval TA₁ is greater than the time interval TA₂.

During times T₀ to T₉ the PCell downlink subframes and the SCell downlink subframes are available for the transmission of data using the PCell and the SCell respectively.

During lines T₀ to T₃, the PCell uplink is available for the transmission of data using the PCell and the SCell uplink is idle or not available for the transmission of data.

At T₃, the UE switches from using the PCell uplink 530 to the SCell uplink 540. Thus at T₃ neither the PCell uplink nor the SCell uplink is available for use by the UE as they are being used for switching uplink frequency. The UE may then transmit data using the SCell uplink at times T₄ and T₅ respectively whilst the PCell uplink is not used or idle.

At T₆ the UE switches back to transmitting data using the PCell. Thus neither the PCell uplink nor the SCell uplink is available for use by the UE.

The UE then continues to transmit data using the PCell uplink for times T₇ . . . T₉ respectively and respective the SCell uplink is idle or unused.

The time required 502 to switch between using the PCell uplink and the SCell uplink is expected to be longer than the delay intervals TA₁ and TA₂ but shorter than the length of a PCell or SCell subframe.

Some embodiments of FIG. 5A may provide separate UCIs based on time division multiplexing (TDM). This enables the UE to switch the UL frequency based on a switching pattern pre-configured by the network such the UCI feedback corresponding to the DL transmissions on the PCell (F1) and the SCell (F2) are provided on the respective UL frequencies. The DL transmissions on the PCell and the SCell are synchronised by the network such that their time slots coincide. The time needed for the UE to switch the RF frequency for the UL may be in the region of 200·s (micro seconds), thus at least two subframes for each of the uplinks per 10 ms radio frame may need to be reserved for the UE to switch the UL frequency from F1 to F2 and then back to F1. This means that these frames cannot be used for UL scheduling by either the PCell or the SCell during a switch over. This may result in a reduction to scheduling flexibility and a potential decrease in the user throughput on the UL.

FIG. 5B shows a timing diagram in accordance with some embodiments which differs from FIG. 5A in that frame transmissions on the SCell downlink 522 precede those on the PCell downlink 512 by a time period DL OFFSET 504. DL OFFSET is longer than the switching time 502 but shorter than the subframe intervals. It is noted that in some embodiments the PCell downlink frames 512 may precede the SCell downlink frames 522 by the time period offset 504.

As the SCell downlink frame intervals 520 have been shifted, the SCell uplink intervals 540 are also shifted as delay periods TA₁ and TA₂ have not changed. Thus there is a larger delay between the transmission of the SCell uplink frames and the PCell uplink frames in FIG. 5B. When the UE wishes to switch from using the PCell uplink to using the SCell uplink at T₃ data cannot be transmitted using the uplink. However, when the UE wishes to switch back to the PCell uplink after T₅, the delay between the PCell and the SCell uplink frames means that the beginning of the changeover SCell subframe coincides with the end of a PCell subframe which was not being used for transmissions. Thus the subsequent PCell subframe which is unavailable for use by the UE in FIG. 5A, is available for use in by the UE FIG. 5B as it is not required for the switchover procedure.

Some embodiments may use a network-configured timing offset between the DL transmissions from the PCell and the SCell. As the time needed for the UE to switch the UL RF frequency is less than half the length of a subframe, offsetting the DL transmissions of the PCell and the SCell may reduce the number of subframes in one radio frame which need to be muted in order for the UE to switch from the PCell frequency to the SCell frequency and then back again to the PCell frequency. This may increase scheduling flexibility and user throughput opportunities as the number of available uplink transmission subframes is increased.

In some embodiments the timing advance (TA) on a PCell may be larger than the corresponding TA on the SCell because the propagation delay experienced in a macro cell is typically larger than the propagation delay experienced in a small cell.

In some embodiments the TA on the SCell may be larger than the TA on PCell.

Some embodiments may use the time division duplexing (FDD) on both the PCell and SCell. Some embodiments may use the time division duplexing (TDD) on both the PCell and the SCell. Some embodiments may use a mixture of frequency division duplexing and time division duplexing on one or more of the PCells and/or SCells.

In some embodiments the time needed for the RF unit in the UE to switch the frequency UL may be less than half the length of subframe. For example, in some embodiments, which may be suitable for use in LTE, the switching time may be less that 500·s (micro seconds) when the length of an LTE subframe in 1 ms.

In some embodiments, the timing offset DLOFFSET between DL transmissions on PCell and SCell may be configured such that it satisfies the following requirements:

TSWITCH−ΔTP≦DLOFFSET (1)

(TSubframe−TSWITCH)−ΔTP≧DLOFFSET (2)

ΔTP=2*TPPCell−TPSCell (3)

wherein:
TSWITCH is the time needed for the UE RF unit to switch UL frequency;
Tsubframe is the length of an LTE subframe (i.e. 1 ms);
TPPCell is the DL propagation delay between the UE and the transmission point of the PCell; and
TPSCell is the DL propagation delay between the UE and the transmission point of the SCell.

FIG. 6 shows a flow chart of the method performed by the UE in some embodiments. The UE determines whether the PCell or the SCell is to be used for the uplink transmissions 600.

When the PCell is being used 601 the SCell downlink subframe is received at time T−DLOFFSET+TPSCell 603. The PCell downlink subframe is received at time T+TPPCell 605 and the PCell uplink subframe is transmitted at time T+TPPCell—TA₁ 606.

When the SCell is being used 602 the SCell downlink subframe is received at time T−DLOFFSET+TPSCell 603. The SCell uplink subframe is transmitted at time T−DLOFFSET−TA₂ 604 and the PCell downlink subframe is received at time T+TPPCell 605.

In some embodiments the network may not be aware of the exact difference in propagation delay experienced by the PCell and the SCell. However, the maximum difference in propagation delay between the PCell and the SCell may be estimated based on the maximum distance between the transceiver transmitting the PCell and the transceiver transmitting the SCell. This may depend on the cell sizes. The timing offset between the DL transmissions on the PCell and the SCell may be determined based on the estimation of the maximum difference in propagation delay between the PCell and the SCell.

In embodiments where the PCell and SCell are provided by a macro cell and a small cell as when the small cell is within the coverage area provided the larger cell, the expected distance between the PCell and the SCell may be relatively short.

For example, assuming the maximum difference between the PCell and the SCell is approximately 600 meters, then the maximum difference between the propagation delay on the PCell and the SCell when the UE is located close to the SCell may be estimated to be approximately 2·s using any suitable estimation technique. As the time needed for the UE to switch RF frequency in UL may be approximately 200·s, the timing offset between DL transmissions may be set so such that approximately 198·s<DL_{OFFSET}<798·s. In other words, it may be possible to configure the DL timing offsets even without precisely knowing the difference in propagation delay between the PCell and the SCell, as well as assuming potentially different UE implementations which may have different switching times. In some embodiments the estimates may be based on the propagation speed of the electromagnetic waves.

It will be appreciated that the above numerical examples are nonlimiting and that some embodiments may have longer or shorter propagation delays, switching times, downlink offsets and/or subframe lengths.

Some embodiments may enable the inter-site carrier aggregation of macro and pico cells for a UE.

In some embodiments the network may configure the offset and/or adjust the DL transmissions of a PCell and a SCell using the DLOFFSET to reduce the UE switching gap for UEs supporting dual-carrier DL and single-carrier UL transmissions, such that one subframe per radio frame need to be muted in the UL at the UE in order for the UE to switch from the PCell frequency (F1) to the SCell frequency (F2) and then back again to the PCell frequency (F1).

In some embodiments the PCell downlink transmissions may precede the SCell downlink transmissions.

In some embodiments the SCell downlink transmissions may precede the SCell downlink transmissions.

Some embodiments may be used to switch between a PCell and at least one SCell.

Some embodiments may be used to switch between a plurality of SCells.

Some embodiments may use the timing advance to enable UL signals from different UEs, which may have different propagation delays, to be received synchronously at the corresponding base station. In some embodiments the TA may be applied based on the timing of reception of a corresponding DL.

Some embodiments may be used for transmitting and/or receiving communication using a range of electromagnetic frequencies for example radio frequencies, microwave frequencies etc.

The communications may be transmitted and/or received using at least one of wired and/or wireless communication.

In some embodiments there may be one or more SCells.

In some embodiments the muting requirements in the UL for the UE may be reduced by adding a timing offset between the DL transmissions of the PCell and the SCell.

In some embodiments a network-configured timing offset may be provided between the DL transmissions of the PCell and the SCell. This may minimise the UE muting requirements for the uplink of a UE operating with inter-site CA in DL and single carrier uplink transmissions.

In some embodiments, the network may estimate the maximum difference in propagation delay between the PCell and the SCell, based on the maximum distance between the PCell transceiver and the SCell transceiver. In some embodiments the network may determine the timing offset between the DL transmissions on the PCell and the SCell, (DLOFFSET), based on this propagation delay.

In general a primary cell or carrier may be considered to be one where control information is at least one of provided to or from a UE. When the primary cell or carrier is activated, this control information is not provided via the secondary carrier or secondary cell. This control information may be required for use of the second carrier or cell. When the primary cell or carrier is deactivated, any one or more of the embodiments may be used

Embodiments may be used where there is carrier aggregation in scenarios other than the LTE situations described above.

It should be appreciated that the embodiments may be implemented by one or more computer programs running on one or more processors, hardware, firmware, dedicated circuits or any combinations of two or more of the above. Some embodiments may make use of one or more memories. For example the computer programs may comprise computer executable instructions which may be stored in one or more memories. When run, the computer program(s) may use data which is stored in one or more memories.

It is noted that whilst embodiments have been described in relation to certain architectures, similar principles can be applied to other communication systems where carrier aggregation is provided. For example, this may be the case in application where no fixed access nodes are provided but a communication system is provided by means of a plurality of user equipment, for example in adhoc networks. Also, the above principles can also be used in networks where relay nodes are employed for relaying transmissions. Therefore, although certain embodiments were described above by way of example with reference to certain exemplifying architectures for wireless networks, technologies and standards, embodiments may be applied to any other suitable forms of communication systems than those illustrated and described herein. It is also noted that different combinations of different embodiments are possible. It is also noted herein that while the above describes exemplifying embodiments of the invention, there are several variations and modifications which may be made to the disclosed solution without departing from the spirit and scope of the present invention.

1. A method comprising:
receiving signals at a first frequency and at a second frequency; and
switching between the first frequency and the second frequency during one of a plurality of subframes within a radio frame for transmission subsequent to said receiving.

2. A method as claimed in claim 1, wherein said first frequency signal and said second frequency signal are offset by a timing offset.

3. A method as claimed in claim 2, wherein said timing offset is determined to be at least as long as a time required for said switching between said first frequency and said second frequency, and/or to be shorter than half the time required for one of said subframes.

4. (canceled)

5. A method as claimed in claim 2 wherein said timing offset is determined using:
TSWITCH−ΔTP≦timing offset;
(TSubframe−TSWITCH)−ΔTP≧timing offset;
wherein:
ΔTP=2*TPPCell—TPSCell;
TSWITCH is a time required for said switching between said first frequency and said second frequency;
Tsubframe is the length of said subframe;
TPPCell is a propagation delay associated with said signal transmitted at said first frequency; and
TPSCell is a propagation delay associated with said signal transmitted at said second frequency.

6. (canceled)

7. (canceled)

8. A method comprising:
determining a timing offset between first transmissions in a first frequency and second transmissions in a second frequency to a communication device; and
offsetting subsequent transmissions in the first frequency and in the second frequency to the communication device using the timing offset.

9. A method as claimed in claim 8 wherein said timing offset is at least as long as a time required by a user equipment to switch between said first frequency and said second frequency, and/or is shorter than half the length of a subframe within a radio frame for transmission.

10. (canceled)

11. A method as claimed in claim 8, wherein said timing offset further allows for at least one of a first propagation delay associated with said first transmission and a second propagation delay associated with said second transmissions.

12. A method as claimed in claim 8 wherein said timing offset is determined using:
TSWITCH−ΔTP≦timing offset;
(TSubframe−TSWITCH)−ΔTP≧timing offset;
wherein:
ΔTP=2*TPPCell−TPSCell;
TSWITCH a time required by a user equipment to switch between said first frequency and aid second frequency;
Tsubframe is a length of a subframe within a radio frame for transmission;
TPPCell is a propagation delay associated with said first transmissions; and
TPSCell is a propagation delay associated with said second transmissions.

13. A method as claimed in claim 8, wherein at least one of said first and second frequency is associated with at least one primary cell.

14. A method as claimed in claim 8, wherein at least one of said first and second frequency is associated with at least one secondary cell.

15. (canceled)

16. An apparatus comprising:
at least one processor;
and at least one memory including program code;
the at least one memory and the computer program configured to, with the at least one processor cause the apparatus to perform:
receiving signals at a first frequency and at a second frequency; and
switching between the first frequency and the second frequency during one of a plurality of subframes within a radio frame for transmission subsequent to said receiving.

17. An apparatus as claimed in claim 16, wherein said first frequency signal and said second frequency signal are offset by a timing offset.

18. An apparatus as claimed in claim 17, wherein said timing offset is determined to be at least as long as a time required for said switching between said first frequency and said second frequency, and/or to be shorter than half the time required for one of said subframes.

19. (canceled)

20. An apparatus as claimed in claim 16 wherein said timing offset is determined using:
TSWITCH−ΔTP≦timing offset;
(TSubframe−TSWITCH)−ΔTP≧timing offset;
wherein:
ΔTP=2*TPPCell—TPSCell;
TSWITCH is a time required for said switching between said first frequency and said second frequency;
Tsubframe is the length of said subframe;
TPPCell is a propagation delay associated with said signal transmitted at said first frequency; and
TPSCell is a propagation delay associated with said signal transmitted at said second frequency.

21. (canceled)

22. (canceled)

23. (canceled)

24. An apparatus comprising:
at least one processor;
and at least one memory including program code;
the at least one memory and the computer program configured to, with the at least one processor cause the apparatus to perform:
determining a timing offset between first transmissions in a first frequency and second transmissions in a second frequency to a communication device; and
offsetting subsequent transmissions in the first frequency and in the second frequency to the communication device using the timing offset.

25. An apparatus as claimed in claim 24 wherein said timing offset is at least as long as a time required by a user equipment to switch between said first frequency and said second frequency, and/or is shorter than half the length of a subframe within a radio frame for transmission.

26. (canceled)

27. An apparatus as claimed in claim 24 wherein said timing offset further allows for at least one of a first propagation delay associated with said first transmission and a second propagation delay associated with said second transmissions.

28. An apparatus as claimed in claim 24 wherein said timing offset is determined using:
TSWITCH−ΔTP≦timing offset;
(TSubframe−TSWITCH)−ΔTP≧timing offset;
wherein:
ΔTP=2*TPPCell−TPSCell;
TSWITCH a time required by a user equipment to switch between said first frequency and aid second frequency;
Tsubframe is a length of a subframe within a radio frame for transmission;
TPPCell is a propagation delay associated with said first transmissions; and
TPSCell is a propagation delay associated with said second transmissions.

29. (canceled)

30. An apparatus as claimed in claim 16 wherein at least one of said first and second frequency is associated with at least one primary cell.

31. An apparatus as claimed in claim 16 wherein at least one of said first and second frequency is associated with at least one secondary cell.
